(19) United States
(12) Patent Application Publication
(10) Pub. No.: US 2025/0057081 A1
(43) Pub. Date: Feb. 20, 2025

(54) Harvester Production Parameter Capturing System and Method of Use

(71) Applicant: Blake Foster, Henry, SD (US)

(72) Inventor: Blake Foster, Henry, SD (US)

(21) Appl. No.: 18/234,861

(22) Filed: Aug. 16, 2023

(51) Int. Cl. A01D 41/127; A01B 79/00; G06V 30/148

(52) U.S. Cl. CPC A01D 41/1275; A01B 79/005; G06V 30/153

(57) ABSTRACT

A harvest production parameter capturing system for crop yield determination includes programming code, which is selectively installable on an electronic device and enables it for optical character recognition of text in an image of a display of a digital scale, thereby allowing determination of a weight of a load. The programming code enables the electronic device to display on its screen an interface allowing for entry of a plurality of parameters that characterize the load. Also included is a server, which is in communication with the electronic device allowing for transmission of the weight of the load and the parameters to the server, which writes them to data tables that are associated with a user. The server is programmed to perform data aggregation and analysis on the weight of the load and the parameters and to communicate results from the data aggregation and analysis to the electronic device.

### CROSS-REFERENCE TO RELATED APPLICATIONS

Not Applicable

### STATEMENT REGARDING FEDERALLY SPONSORED RESEARCH OR DEVELOPMENT

Not Applicable

### THE NAMES OF THE PARTIES TO A JOINT RESEARCH AGREEMENT

Not Applicable

### INCORPORATION-BY-REFERENCE OF MATERIAL SUBMITTED ON A COMPACT DISC OR AS A TEXT FILE VIA THE OFFICE ELECTRONIC FILING SYSTEM

Not Applicable

### STATEMENT REGARDING PRIOR DISCLOSURES BY THE INVENTOR OR JOINT INVENTOR

Not Applicable

### BACKGROUND OF THE INVENTION

### (1) Field of the Invention

The disclosure relates to data capturing systems and more particularly pertains to a new data capturing system for crop yield determination.

### (2) Description of Related Art including information disclosed under 37 CFR 1.97 and 1.98

The prior art relates to data capturing systems which utilize digital scales but which do not utilize optical character recognition to read a digital display that is operationally engaged to a load cell. The prior art also relates to data capturing systems which do not utilize wireless communication between a load cell and a user's electronic device that is in communication with a server.

### BRIEF SUMMARY OF THE INVENTION

An embodiment of the disclosure meets the needs presented above by generally comprising programming code, which is selectively installable on an electronic device of a user and enables the electronic device for optical character recognition of text in an image of a display of a digital scale that is captured by a camera of the electronic device. The electronic device thus is configured to determine a weight of a load that is measured by the digital scale. The programming code enables the electronic device to display an interface on a screen of the electronic device, with the interface being configured for entry of a plurality of parameters characterizing the load. Also included is a server, which is in communication with the electronic device. The programming code enables the electronic device to transmit the weight of the load and the plurality of parameters characterizing the load to the server. A set of data tables is positioned on the server and is associated with the user. The server is programmed to write the weight of the load and the plurality of parameters characterizing the load to a respective one of the set of data tables, to perform data aggregation and analysis, and to communicate results from the data aggregation and analysis to the electronic device.

Another embodiment of the disclosure includes a production parameter capture system, which comprises a server, a tractor towing a grain cart, a digital scale, which comprises a load cell that is operationally engaged to the grain cart and a display, which is communicatively engaged to the load cell and which is positioned in a cab of the tractor, and an electronic device, typically a smartphone, which is in communication with the server. Programming code positioned on the electronic device enables it for optical character recognition of text in an image of the display that is captured by a camera of the electronic device. The electronic device thus is configured to determine a weight of a load that is measured by the digital scale. The programming code also enables the electronic device to display an interface on a screen of the electronic device, with the interface being configured for entry of a plurality of parameters characterizing the load. The programming code enables the electronic device to transmit the weight of the load and the parameters to the server. A set of data tables is positioned on the server and is associated with a user. The server is programmed to write the weight of the load and the plurality of parameters to a respective one of the set of data tables, to perform data aggregation and analysis, and to communicate results from the data aggregation and analysis to the electronic device.

There has thus been outlined, rather broadly, the more important features of the disclosure in order that the detailed description thereof that follows may be better understood, and in order that the present contribution to the art may be better appreciated. There are additional features of the disclosure that will be described hereinafter and which will form the subject matter of the claims appended hereto.

The objects of the disclosure, along with the various features of novelty which characterize the disclosure, are pointed out with particularity in the claims annexed to and forming a part of this disclosure.

### BRIEF DESCRIPTION OF SEVERAL VIEWS OF THE DRAWING(S)

The disclosure will be better understood and objects other than those set forth above will become apparent when consideration is given to the following detailed description thereof. Such description makes reference to the annexed drawings wherein:

FIG. 1 is an in-use view of a harvest production parameter capturing system according to an embodiment of the disclosure.

FIG. 2 is a detail view of an embodiment of the disclosure.

FIG. 3 is an in-use view of an embodiment of the disclosure.

FIG. 4 is a block diagram of an embodiment of the disclosure.

### DETAILED DESCRIPTION OF THE INVENTION

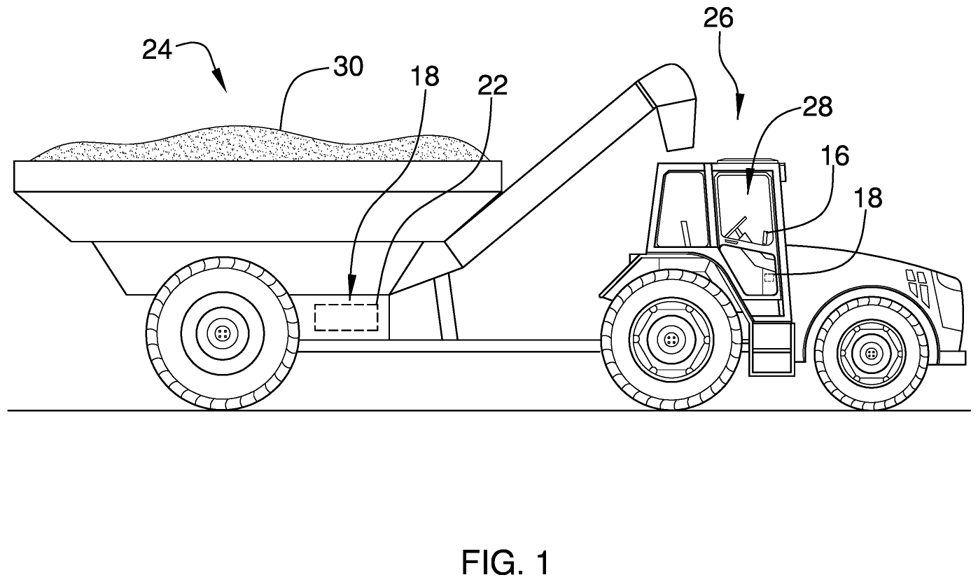

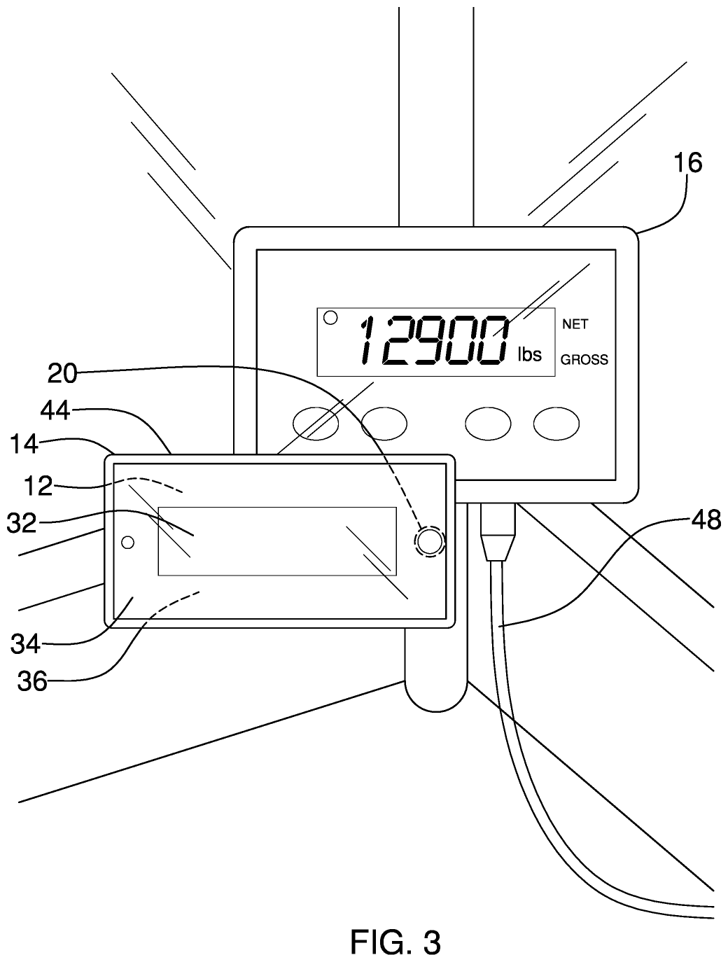

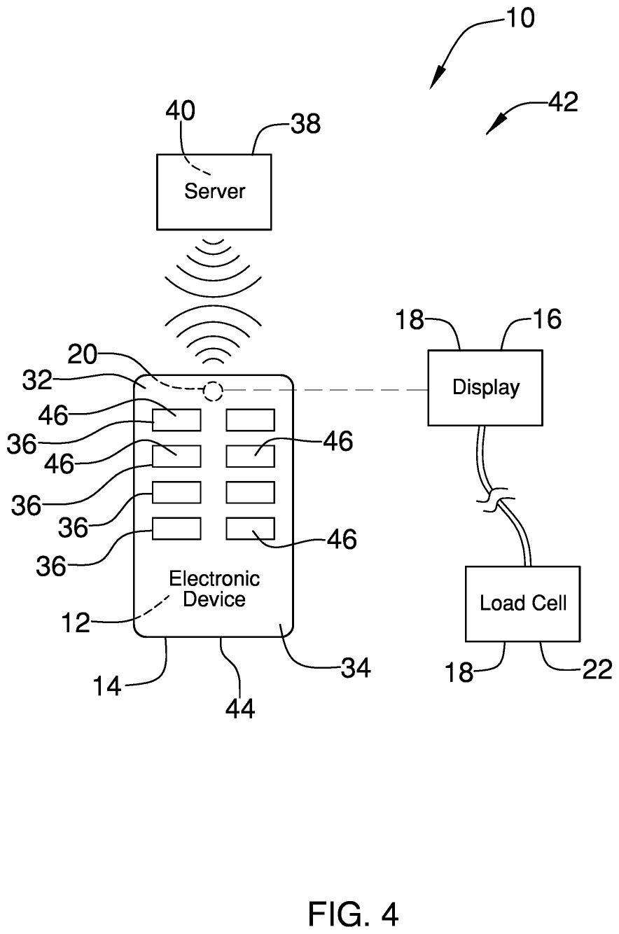

With reference now to the drawings, and in particular to FIGS. 1 through 4 thereof, a new data capturing system embodying the principles and concepts of an embodiment of the disclosure and generally designated by the reference numeral 10 will be described.

As best illustrated in FIGS. 1 through 4, the harvest production parameter capturing system 10 generally comprises programming code 12, which is selectively installable on an electronic device 14 of a user and enables the electronic device 14 for optical character recognition (OCR) of text in an image of a display 16 of a digital scale 18 that is captured by a camera 20 of the electronic device 14. OCR software is well known in the prior art and any such software, such as that provided by Anyline GmbH, Vienna, Austria, is anticipated by the present invention. Anyline GmbH's software has been used to read digital utility meters, analog meters, barcodes, license plates, and the like, but has not been used to process images of a display 16 of a digital scale 18.

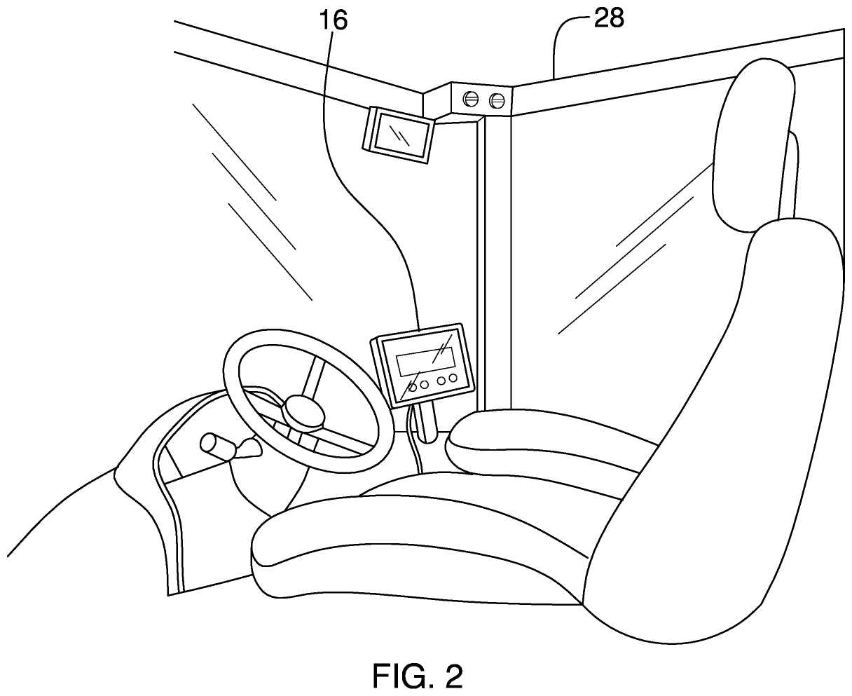

The digital scale 18 comprises a load cell 22 that is communicatively engaged with the display 16, such as by use of a transmitter and a receiver (not shown), which are operationally engaged to the load cell 22 and to the display 16, respectively, or a communication cable 48, which is operationally engaged to and which extends between the load cell 22 and the display 16. The load cell 22 is operationally engaged to a grain cart 24 being towed by a tractor 26, as is shown in FIG. 1, or to a grain tank of a combine harvester (not shown). The display 16 typically would be positioned within a cab 28 of the tractor 26, as is shown in FIG. 2.

The electronic device 14 thus is configured to determine a weight of a load 30, typically grain, that is measured by the digital scale 18. The programming code 12 enables the electronic device 14 to display 16 an interface 32 on a screen 34 of the electronic device 14, with the interface 32 being configured for entry of a plurality of parameters 36 characterizing the load 30 into a plurality of entry boxes 46. The plurality of parameters 36 characterizing the load 30 includes one or more of a field identifier, a field portion identifier, a field size, a field portion size, a crop type identifier, a seed type identifier, and a test weight. Typically, the field size and the field portion size would use acres as the unit of measurement, although the present invention anticipates of use of hectares as the unit of measurement for the field size and the field portion size. The present invention also anticipates the plurality of parameters 36 including other parameters 36, such as, but not limited to, date of planting the crop, seeds per acre, date(s) of fertilizer application(s), type(s) of fertilizer(s) applied, date(s) of herbicide application(s), type(s) of herbicide(s) applied, rainfall amounts and dates, irrigation amounts and dates, or the like.

The programming code 12 also may associate a date and time with each weight determination of a load 30 and may enable manual entry of one or more of a weight of the load 30 and a date and a time for the weight determination of the load 30. Manual entry of the weight of the load 30 and the date and a time for the weight determination of the load 30 would be useful should the user forget to capture the weight using the electronic device 14 or if the digital scale 18 is not working properly.

Also included is a server 38, which is in communication with the electronic device 14. The programming code 12 enables the electronic device 14 to transmit the weight of the load 30 and the plurality of parameters 36 characterizing the load 30 to the server 38. A set of data tables 40 is positioned on the server 38 and is associated with the user. The server 38 is programmed to write the weight of the load 30 and the plurality of parameters 36 characterizing the load 30 to a respective one of the set of data tables 40, to perform data aggregation and analysis, and to communicate results from the data aggregation and analysis to the electronic device 14. The results from the data aggregation and analysis include total yield per field, total yield per field portion, and yield per acre, which typically would be expressed in bushels per acre.

In today's parlance, the harvest production parameter capturing system 10 could be described as a mobile application for capturing, storing, and reviewing production parameters in one organized, digital location. As would be typical for such mobile applications, the programming code 12 of the harvest production parameter capturing system 10 is anticipated to enable a user to create an account, enter payment details, authorize additional users, and the like.

In contrast to current standard operating procedures for most farms, wherein weights are recorded by hand, the weights are summed to provide a total weight, and calculations for yield are performed to track a field's annual production history, the harvest production parameter capturing system 10 provides an accurate, easy to perform, and affordable way for farmers to capture, organize, and store harvest production data in one easily accessible place. The data acquired assists a farming operation in determining total harvest production from each farm field for each year for annual reporting of these figures to government agencies and crop insurance agents. The data acquired and organized also assists in evaluation of seed performance and thereby facilitates improvement of future seed procurement and planting decisions. The harvest production parameter capturing system 10 is anticipated to be far less expensive than currently available systems and to be backward compatible with farming equipment already in use.

The present invention anticipates the server 38 and the programming code 12 of the harvest production parameter capturing system 10 being adapted for use in other industries and circumstances, such as, but not limited to, dump trucks, garbage trucks, semitrucks, dairy trucks, or the like. The present invention also anticipates the server 38 and the programming code 12 of the harvest production parameter capturing system 10 being adapted for use with field spraying equipment, thereby enabling the user to determine and to record application rates of fertilizers and herbicides.

The present invention also anticipates a production parameter capture system 42, which comprises a server 38, a tractor 26 towing a grain cart 24, a digital scale 18, and an electronic device 14, typically a smartphone 44, which is in communication with the server 38. The digital scale 18 comprises a load cell 30, which is operationally engaged to the grain cart 24, and a display 16, which is communicatively engaged to the load cell 30 and which is positioned in a cab 28 of the tractor 26. The electronic device 14 has positioned thereupon programming code 12 enabling the electronic device 14 for optical character recognition of text in an image of the display 16 that is captured by a camera 20 of the electronic device 14. The electronic device 14 thus is configured to determine a weight of a load 30 that is measured by the digital scale 18.

The programming code 12 also enables the electronic device 14 to display 16 an interface 32 on a screen 34 of the electronic device 14, with the interface 32 being configured for entry of a plurality of parameters 36 characterizing the load 30. The programming code 12 enables the electronic device 14 to transmit the weight of the load 30 and the plurality of parameters 36 characterizing the load 30 to the server 38.

A set of data tables 40 is positioned on the server 38 and is associated with a user. The server 38 is programmed to write the weight of the load 30 and the plurality of parameters 36 characterizing the load 30 to a respective one of the set of data tables 40, to perform data aggregation and analysis and to communicate results from the data aggregation and analysis to the electronic device 14. The present invention anticipates the set of data tables 40 allowing for accumulation of at least three years of data, but there is no practical limit to the number of years of data that can be accumulated.

In use, and by way of a nonlimiting example of operation of the harvest production parameter capturing system 10, the following is an example workflow that is enabled by the programming code 12. A user first downloads the programming code 12 to an electronic device 14, typically a smartphone 44 as these are highly portable and are configured for capturing images and wireless communications. The screen 34 then presents the new user with entry boxes 46 for creating a user account, entering payment details, and authorizing additional users.

The new user or a returning user then can select the current year and touch an “Add New Field” icon, which leads to entry boxes 46 wherein the plurality of parameters 36 that characterize load 30 are entered. These include one or more of a field identifier, a field portion identifier, a field size, a field portion size, a crop type identifier, and a seed type identifier. When harvesting, the user can capture the weight of the load 30 in each grain cart 24 by touching on either a “Scan Load” icon or a “Manual Entry” icon. The “Scan Load” icon actuates the camera 20 and allows the electronic device 14 to capture the weight of the load 30 in the grain cart 24. Typically, and to maintain a high level of accuracy in determining the weight of the load 30, the user would select the Tare or Start/Stop feature on the digital scale 18 prior to transfer of the load 30. The display 16 then would display the weight emptied from the grain cart. Upon emptying of the grain cart 24, the user would touch the “Scan Load” icon to capture the weight that is displayed on the display 16 of the digital scale 18.

The programming code 12 may send the weight of each load 30 to the server 38 either automatically or upon user command for aggregation with weights of prior loads 30 that have been written to the respective data table 40 for the field or field portion. The server 38 may relay interim totals to the electronic device 14. The user repeats the steps until harvesting of the field is completed. The user then determines and enters a test weight for the loads 30 into an associated entry box 46, thereby enabling the server 38 to calculate yields. The server 38 stores at least the last three years of data, inclusive of individual grain cart 24 weights, which can be accessed by the user for viewing by touching of a “History” icon.

It is anticipated that, in subsequent harvest seasons, the programming code 12 would present preloaded entries for the plurality of parameters 36 based on the entries from the prior year. The user could adjust these entries, as needed, to match the crop type, seed type, and the like, for the current year.

With respect to the above description then, it is to be realized that the optimum dimensional relationships for the parts of an embodiment enabled by the disclosure, to include variations in size, materials, shape, form, function and manner of operation, assembly and use, are deemed readily apparent and obvious to one skilled in the art, and all equivalent relationships to those illustrated in the drawings and described in the specification are intended to be encompassed by an embodiment of the disclosure.

Therefore, the foregoing is considered as illustrative only of the principles of the disclosure. Further, since numerous modifications and changes will readily occur to those skilled in the art, it is not desired to limit the disclosure to the exact construction and operation shown and described, and accordingly, all suitable modifications and equivalents may be resorted to, falling within the scope of the disclosure. In this patent document, the word “comprising” is used in its non-limiting sense to mean that items following the word are included, but items not specifically mentioned are not excluded. A reference to an element by the indefinite article “a” does not exclude the possibility that more than one of the element is present, unless the context clearly requires that there be only one of the elements.

I claim:

1. A harvest production parameter capturing system comprising:
programming code being selectively installable on an electronic device of a user, the programming code enabling the electronic device for optical character recognition of text in an image of a display of a digital scale captured by a camera of the electronic device, wherein the electronic device is configured to determine a weight of a load measured by the digital scale, the programming code enabling the electronic device to display an interface on a screen of the electronic device, the interface being configured for entry of a plurality of parameters characterizing the load;
a server in communication with the electronic device, the programming code enabling the electronic device to transmit the weight of the load and the plurality of parameters characterizing the load to the server; and
a set of data tables positioned on the server and being associated with the user, the server being programmed to write the weight of the load and the plurality of parameters characterizing the load to a respective one of the set of data tables, to perform data aggregation and analysis, and to communicate results from the data aggregation and analysis to the electronic device.

2. The harvest production parameter capturing system of claim 1, wherein the digital scale comprises a load cell communicatively engaged with the display.

3. The harvest production parameter capturing system of claim 2, wherein the load cell is operationally engaged to a grain cart being towed by a tractor or to a grain tank of a combine harvester.

4. The harvest production parameter capturing system of claim 3, wherein the display is positioned within a cab of the tractor.

5. The harvest production parameter capturing system of claim 1, wherein the plurality of parameters characterizing the load includes one or more of a field identifier, a field portion identifier, a field size, a field portion size, a crop type identifier, a seed type identifier, and a test weight

6. The harvest production parameter capturing system of claim 1, wherein the programming code associates a date and time with each weight determination of a load.

7. The harvest production parameter capturing system of claim 1, wherein the programming code enables manual entry of one or more of a weight of the load and a date and a time for the weight determination of the load.

8. The harvest production parameter capturing system of claim 1, wherein the results from the data aggregation and analysis include total yield per field, total yield per field portion, and yield per acre.

9. A production parameter capture system comprising:
a tractor towing a grain cart;
a digital scale comprising:
a load cell operationally engaged to the grain cart; and
a display communicatively engaged to the load cell and positioned in a cab of the tractor;
an electronic device having positioned thereon programming code enabling the electronic device for optical character recognition of text in an image of the display captured by a camera of the electronic device, wherein the electronic device is configured to determine a weight of a load measured by the digital scale, the programming code enabling the electronic device to display an interface on a screen of the electronic device, the interface being configured for entry of a plurality of parameters characterizing the load;
a server in communication with the electronic device, the programming code enabling the electronic device to transmit the weight of the load and the plurality of parameters characterizing the load to the server; and
a set of data tables positioned on the server and being associated with a user, the server being programmed to write the weight of the load and the plurality of parameters characterizing the load to a respective one of the set of data tables, to perform data aggregation and analysis, and to communicate results from the data aggregation and analysis to the electronic device.

10. The production parameter capture system of claim 9, wherein the plurality of parameters characterizing the load includes one or more of a field identifier, a field portion identifier, a field size, a field portion size, a crop type identifier, a seed type identifier, and a test weight

11. The production parameter capture system of claim 9, wherein the programming code associates a date and time with each weight determination of a load.

12. The production parameter capture system of claim 9, wherein the programming code enables manual entry of one or more of a weight of the load and a date and a time for the weight determination of the load.

13. The production parameter capture system of claim 9, wherein the results from the data aggregation and analysis include total yield per field, total yield per field portion, and yield per acre.

14. A method of capturing production parameters comprising:
downloading programming code onto an electronic device, the programming code enabling the electronic device for optical character recognition of text in an image of a display of a digital scale captured by a camera of the electronic device, wherein the electronic device is configured to determine a weight of a load measured by the digital scale, the programming code enabling the electronic device to display an interface on a screen of the electronic device, the interface being configured for entry of a plurality of parameters characterizing the load;
entering the plurality of parameters characterizing the load into the interface;
capturing the weight of the load measured by the digital scale; and
sending the plurality of parameters characterizing the load and the weight of the load to a server in communication with the electronic device, the server including:
a set of data tables positioned on the server and being associated with a user, the server being programmed to write the weight of the load and the plurality of parameters characterizing the load to a respective one of the set of data tables, to perform data aggregation and analysis, and to communicate results from the data aggregation and analysis to the electronic device.

15. The method of claim 14, wherein the digital scale comprises a load cell communicatively engaged with the display.

16. The method of claim 15, wherein the load cell is operationally engaged to a grain cart being towed by a tractor or to a grain tank of a combine harvester.

17. The method of claim 14, wherein capturing the weight of the load measured by the digital scale further comprises manually entering the weight of the load measured by the digital scale.

18. The method of claim 14, wherein capturing the weight of the load measured by the digital scale further comprises actuating the camera of the electronic device and allowing the camera to capture the weight of the load provided through the image of the display of the digital scale.

19. The method of claim 14, wherein the programming code sends the weight of the load to the server automatically.

20. The method of claim 14, wherein the programming code sends the weight of the load to the server upon a command for aggregation from the user.
